(19) United States
(12) Patent Application Publication
(10) Pub. No.: US 2016/0208986 A1
(43) Pub. Date: Jul. 21, 2016

(54) OMNILED LIGHT BULB SYSTEM METHODS AND APPARATUS

(71) Applicant: Ed Davis, Tigard, OR (US)

(72) Inventor: Ed Davis, Tigard, OR (US)

(21) Appl. No.: 14/597,663

(22) Filed: Jan. 15, 2015

(51) Int. Cl. F21K 99/00; F21V 19/00; F21V 23/02; F21V 3/04; F21V 29/70

(52) U.S. Cl. CPC F21K 9/135; F21V 3/0436; F21V 29/70; F21V 23/02; F21V 19/003; F21Y 2101/02

(57) ABSTRACT

The present invention is directed to an LED bulb comprising: (a) an OmniLED filament assembly comprising a flexible printed circuit board (PCB) and LED lights; (b) an OmniLED stem configured to support the OmniLED Filament; and a (c) transparent bulb housing that encloses the OmniLED filament and OmniLED stem.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

Embodiments of the present invention relate generally to light bulbs, including a new type of light bulb as well as replacing the filament in incandescent to fluorescent tube lights.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to disclosed embodiments.

Previously known low energy bulbs are not capable of being integrated into existing incandescent bulb cases or form factors and they do not generate omni-directional light equivalent to an incandescent.

Previously known low energy bulbs are not capable of being placed in clear or colored plastic form factors, because they generate too much heat, and/or they're too fragile.

The incandescent light bulbs are being forced to stop production due to their energy inefficiencies. They typically get only a handful of lumens per Watt. Newer LED technologies may generate up to 200 lumens per Watt if properly implemented.

The present state of the art may therefore benefit from systems, methods, devices, and apparatuses for implementing an OMNILED FILAMENT LIGHT BULB and associated packaging as described herein.

### BRIEF SUMMARY OF THE INVENTION

There are several types of lighting that use LED's although the designs are not very effective. They contain too much circuitry which is bulky and costs more to produce and have a shorter Mean Time Before Failure (MTBF). Many require heat sinks or even liquid cooling. Many existing LED bulbs will not dim using standard dimming switches that incandescent lights use. Many embodiments of the OMNILED will dim even the replacement bulbs for fluorescent tubes will dim.

Many have a suboptimal illumination pattern that is far inferior to that of an omni-directional incandescent bulb. Many types contain a step down AC to DC power supply to drive the LED Array. This is bulky and not very aesthetically pleasing to the eye, i.e. very unsightly. They could not easily replace filaments in existing bulb types, especially in clear glass bulbs.

Many use higher wattage or higher voltage bulbs which are much more expensive and do not get the full range of coverage in illumination that may be gained from using more lower wattage bulbs, that may be arranged to provide more thorough illumination. Fluorescent and compact fluorescent lights contain dangerous, poisonous gases. Fluorescent and compact fluorescent lights also require additional circuitry to startup the bulb and generally are not as clean and sleek looking as a typical incandescent light bulb.

The instant invention solves all these issues, in a very aesthetically pleasing, very elegant design. It doesn't require a low voltage DC power supply to drive the LEDs, only a single surface mount bridge IC. Either a tiny 4 pin SOIC, or two tiny SOT-23 devices which are 3 pin. This bridge may be mounted at the base of the stem or even inside the stem that supports the OmniLED Filament.

The OmniLED filament has the same or better illumination pattern as an incandescent. It avoids the perils of poisonous materials and in many cases uses less than one tenth the power of incandescent and less than half the power of compact fluorescents while producing the same or more lumens, in a more omni-directional fashion.

This device could be used in the old glass enclosures used by incandescent or fluorescent light bulbs. It could be installed into their existing production lines with just a few changes in the equipment and assembly processes. It may also be manufactured in a new way using high impact plastics (e.g. lexan, polycarb) or other less expensive plastics. Since the bulb generally burns less than 5 Watts, it may be housed in plastics rather than glass.

In one embodiment the filament substrate is a flexible printed circuit. The filament assembly process may use high speed printed circuit board manufacturing technology like the Fuji CP-VI-4000 Pick and Place machine or equivalent and the Madell IR/Convection Reflow ovens or equivalent.

The OmnLED Series LC Resonance circuit can repetitively reuse energy to light LEDs thereby requiring a very small duty cycle, conserving energy

### BRIEF DESCRIPTION OF THE DRAWINGS

FIG. 1 depicts Prior Art Clear Incandescent Light Bulb having a Typical Tungsten Filament and support structure

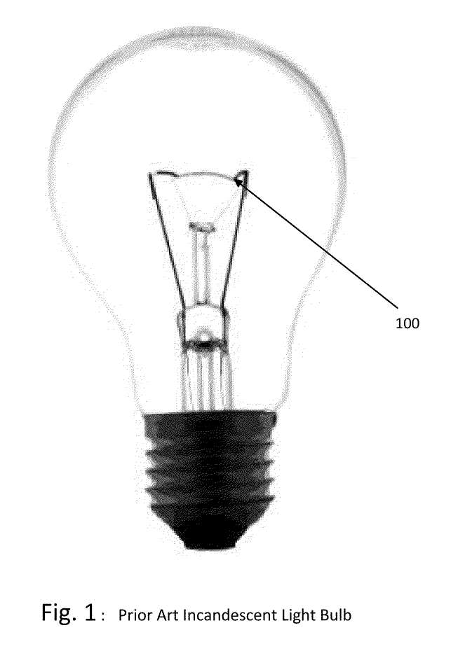

FIG. 2 depicts a OmniLED Filament Light Bulb

FIG. 3 depicts a schematic of one embodiment which uses surface mount package PLCC-4 which contains 4 Pins with two LEDs per package. The LC Tank circuit resonates to recycle each pulse multiple times to multiply the light output.

FIG. 4a depicts the Flexible Printed Circuit Board rolled into 3 legged Cylinders to make an OmniLED Filament subassembly with 39 individual LED's

FIG. 4b depicts the Flexible Printed Circuit Board rolled into 3 legged Cylinders to make an OmniLED Filament subassembly with 21 individual LED's

FIG. 5 depicts the Base Mounting Printed Circuit Board and OmniLED Filament Subassembly of one embodiment.

FIG. 6 depicts The Bulb enclosure, the OmniLED Filament Subassembly, the Base and Final Assembly of one embodiment of the OmniLED bulb.

FIG. 7 depicts a Cutaway view showing one embodiment of OmniLED Base Subassembly Details.

FIG. 8 depicts a fully functional working Prototype 100 Watt equivalent bulb that consumes less than 10% of the energy of an incandescent 100 Watt bulb.

FIG. 9 depicts the OmniLED Filament Finite Element Beam Dispersion Pattern, 120 degree LEDs using SolidWorks.

FIG. 10 depicts another type of OmniLED single stack (triangle) vertical for bulbs & single or dual stack (hexagon) horizontal rows for tubes.

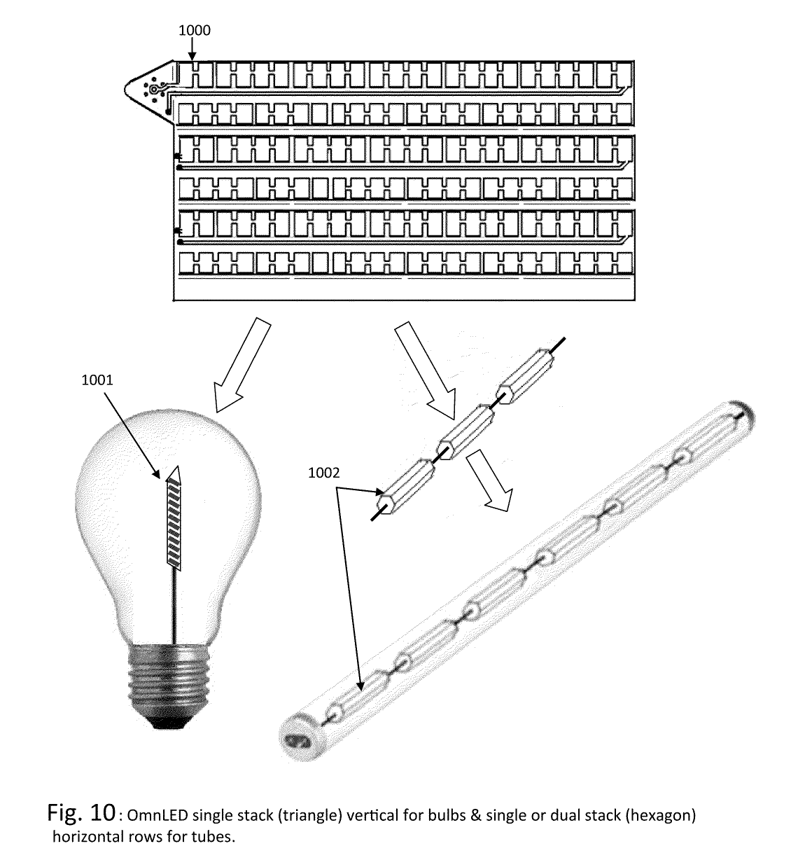

FIG. 11 depicts the OmniLED LC Tank circuit which repetitively reuses energy to light LEDs thereby requiring a very small duty cycle, conserving energy

### DETAILED DESCRIPTION

Described herein are systems, devices, methods, and apparatuses for implementing a OmniLED Filament and a OmniLED Filament Light Bulb.

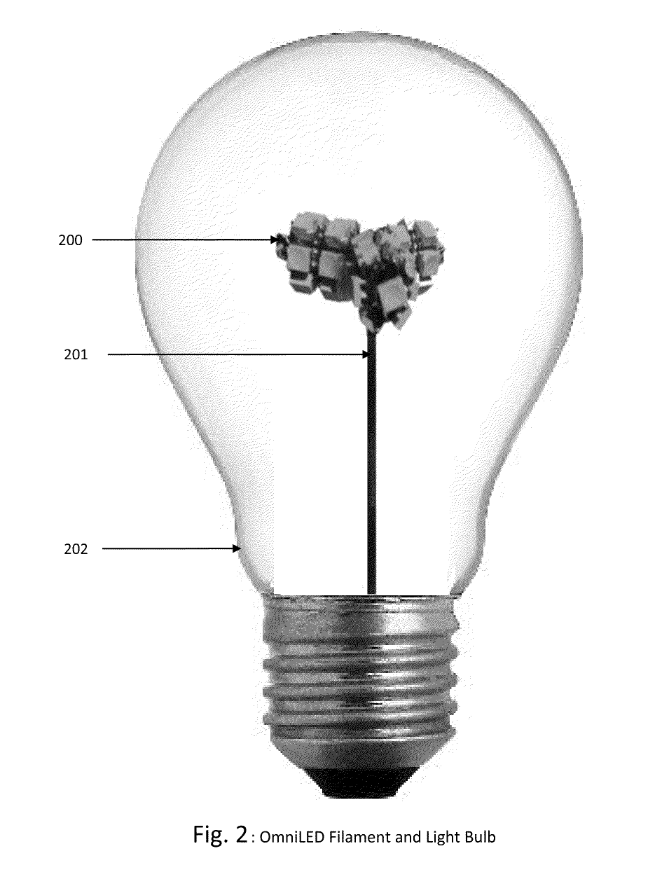

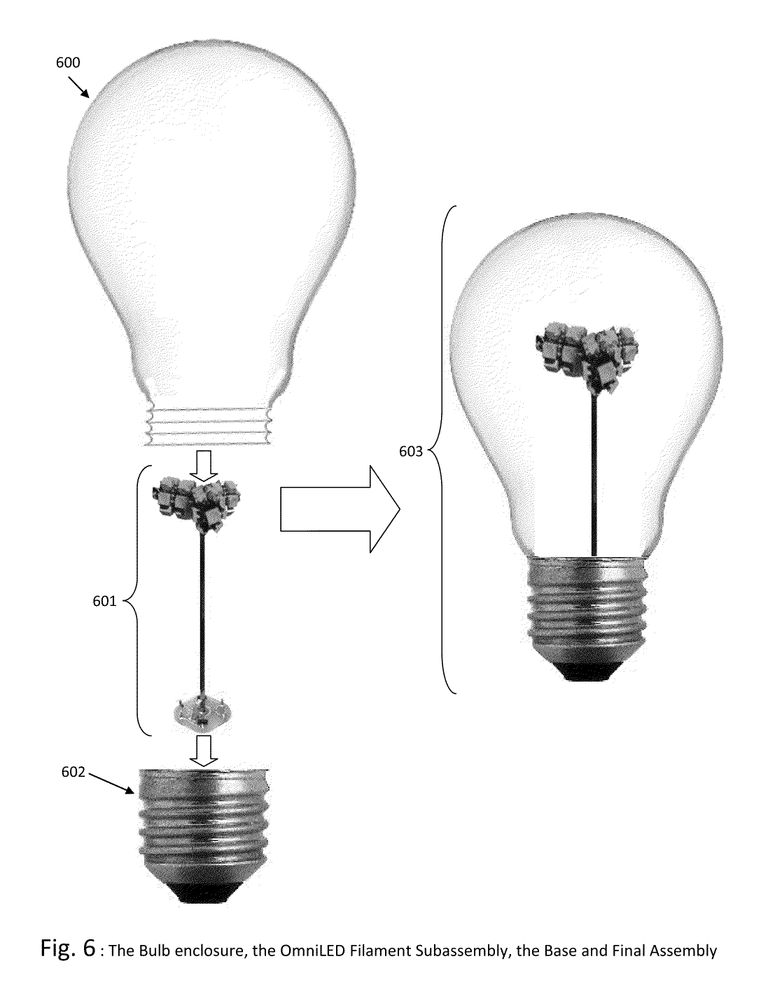

FIG. 2 depicts a complete OmniLED Filament Light Bulb which consists of several pieces including:
1. The OmniLED Filament [200]12. The OmniLED Filament support structure (stem) [201]
3. A Standard A19 style (like old incandescent use) bulb housing and packaging [202] which may be replaced by the new plastic housing illustrated in FIG. 6.

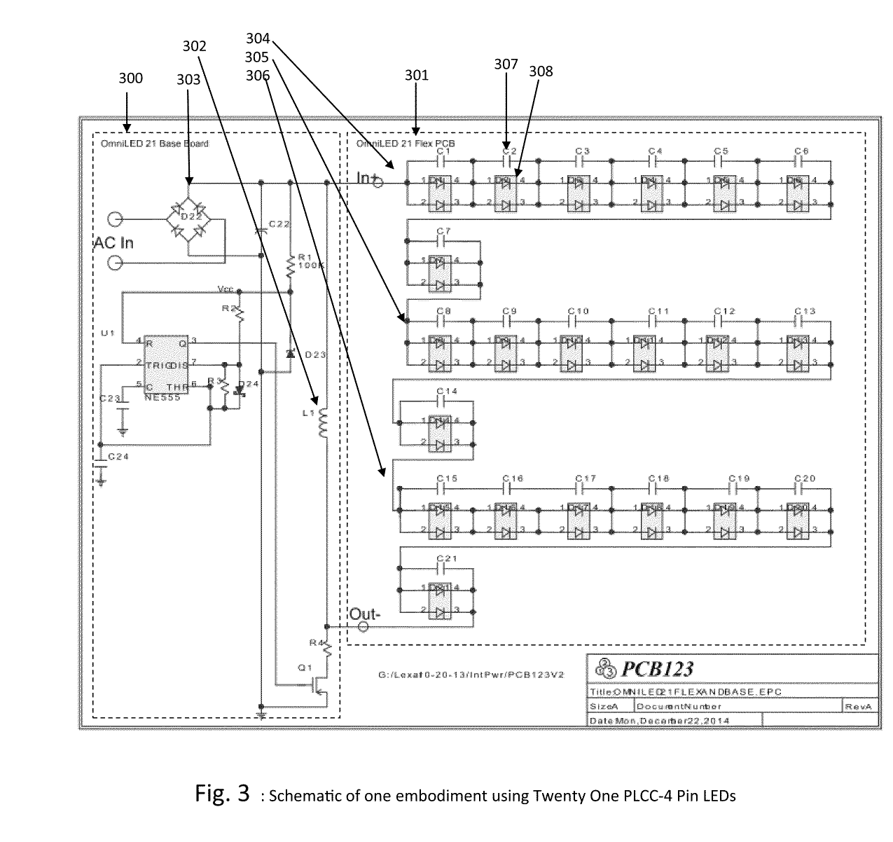

FIG. 3 illustrates a schematic for the OmniLED Baseboard [300] and OmniLED Flex Circuit. [301]. This schematic depicts one embodiment which utilizes 4 pin PLCC type LEDs in that mat contain one or two LEDs in each package (e.g Cree CLA2A-WKW series or the Korea Semiconductor STW8C2SA or the LiteOn LTW-A670 series). Using either 7 or 13 of these on each of the three legs [304, 305, 306]. of the OmniLED flexible printed circuit results in 21 or 39 LEDs total. Each LED is typically 9.5 to 17 lumens at 2.8 to 4.0 Volts and 20 mA to 30 mA per LED. For the 39 LED array that would be a 17×39=663 lumens at 3.2V. That's over 75 lumens/Watt. The pulsing DC effect actually generates even more lumens at less Watts, because the peaks are higher and valleys lower and the lumen output spikes dramatically on each peak. Small capacitors [307]. on the order of a few microfarads, are used in parallel with each LED along with an inductor [302] on the Base Board to form an LC Tank circuit that is tuned to resonance frequency to generate even more lumens per Watt by recycling the energy several times until the effective resistance of the LEDs dampens it down, then another pulse is applied and the process repeats.

There is no bulky power supply or power conditioning circuitry, only a small surface mount full wave bridge rectifier [303] that converts AC to pulsing DC. This bridge is a tiny SO-4 surface mount part in some embodiments or two SOT-23 Half-Bridge parts in other embodiments. They easily fit on the small Printed Circuit Board [Base Board] at the base of the stem.

The OmniLED Filament assembly is a Flexible Printed Circuit Board with a hub and three legs [304, 305, 306]. One embodiment utilizes 13 LEDs [308] on each of the three legs of the OmniLED for a total of 39 LEDs. Another embodiment uses 7 LEDs [308] per leg for a total of 21 LEDs. Note that the Hexagonal Cylinder is not a limitation, other configurations such as Septahedral, Octagonal, etc. may work just as well. The number 21 to 39 may be varied as well for different light intensities, etc. as well as different colors and shades of light.

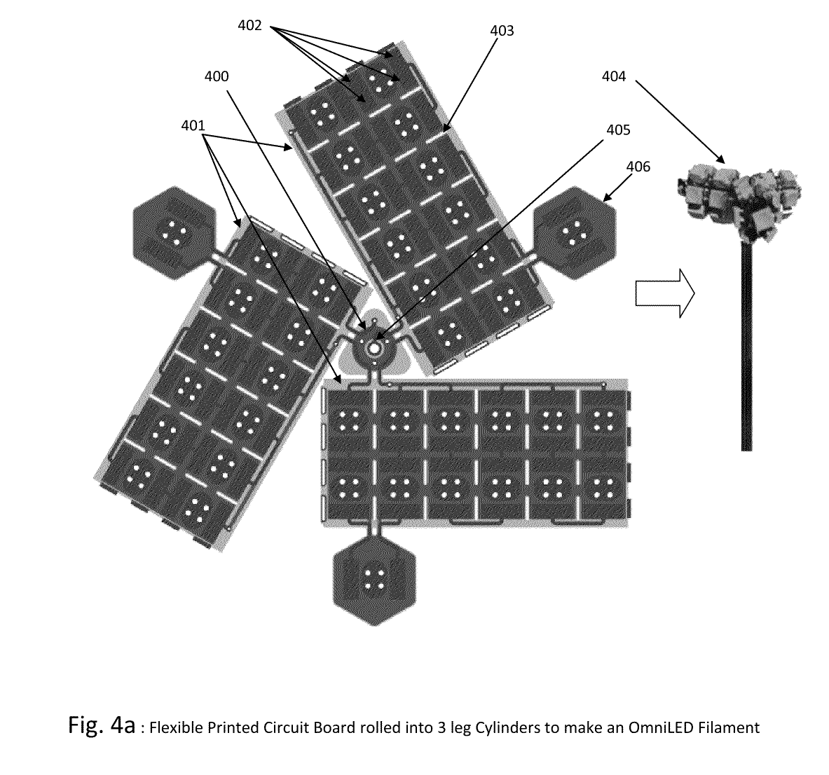

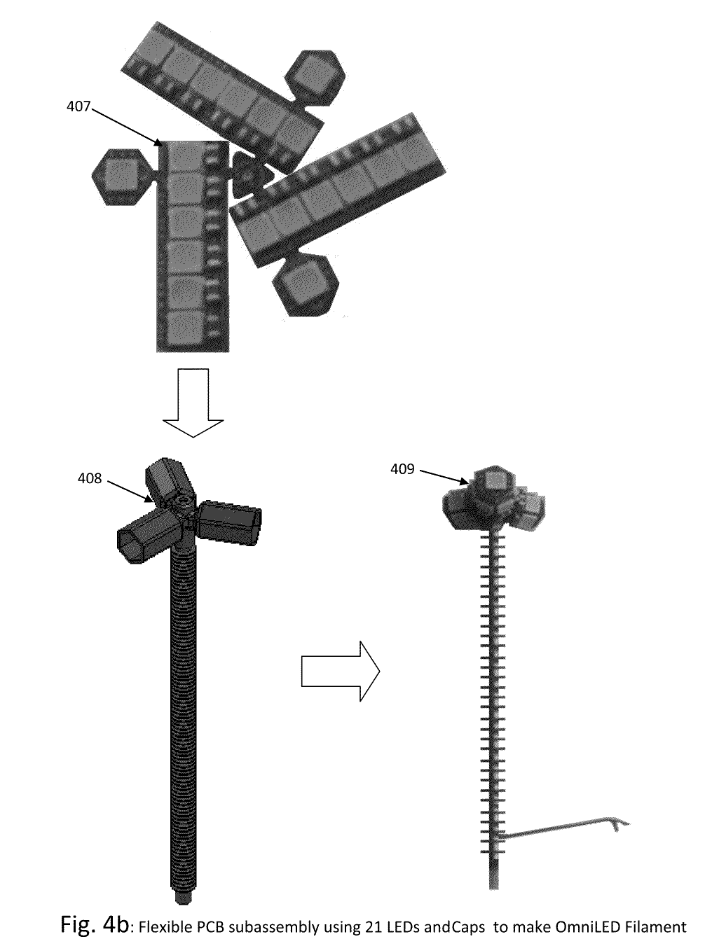

FIG. 4 depicts the Flexible Printed Circuit Board. The hub of the Flexible Printed Circuit Board [400] connects to a bifilar wire in this embodiment that comes up through the center of the support structure (stem). It is soldered to the center hub to supply power to the LED Array.

Each leg of the Flexible Printed Circuit Board [401] in FIG. 4 is rolled into a Hexagonal Cylinder in this embodiment to form one of the three OmniLED Filament legs.

Each Leg of the Flexible Printed Circuit Board [401] that makes up the OmniLED contains mounting pads for either 7 or 13 LEDs in these two embodiments. Each of these PLCC-4 type LED devices mount on four mounting pads [402] in many embodiments. Each device in this embodiment contains 2 LEDs, other embodiments may contain more or less LEDs per device.

In these two embodiments the individual LEDs may be Cree CLA-2A-WKW series or Seoul Semiconductor STW8C2SA or equivalents.

The center of the Flexible Printed Circuit Board [400] contains the Positive Via and Common via wher the bifilar wire is attached that runs through the inside of the support structure (stem). They may be soldered, crimped, spot welded, and/or screw mounted.

The topmost via [405] is attached underneath the Flexible Printed Circuit to the ring of six vias below [405]. The stems diameter is the same diameter as the hole in the Base board down below. It is plugged into the baseboard, then a #1/72 screw is used to secure it to the Edison base, after the bulb is filled with Helium through that screw hole.

Each Leg of the Flexible PCB contains laser cutout lines [403] to facilitate easy folding and rolling into a hexagonal or septahedral cylinder. There is one laser cutout line [403] between each pair of LED devices.

All three Legs of the flex circuits are rolled up and adhered to the OmniLED Filament subassembly [404] using electrically insulating, thermally conductive adhesive such as Arctic Alumina™ or equivalent. This subassembly is attached to the stem to form the complete OmniLED Filament and support structure subassembly ready to be installed into a Light Bulb baseboard and base.

The 7^{th} LED device on each leg [406] is mounted on a spur off each of the three legs. There is one laser cut between the two traces to allow easy folding, so that it becomes an end-cap on each of the three cylinders. The three end-caps are folded and the LED on each end produces light straight out to the sides in a plane parallel to the base of the bulb in the 21 LED embodiments and similarly in the 39 LED embodiments.

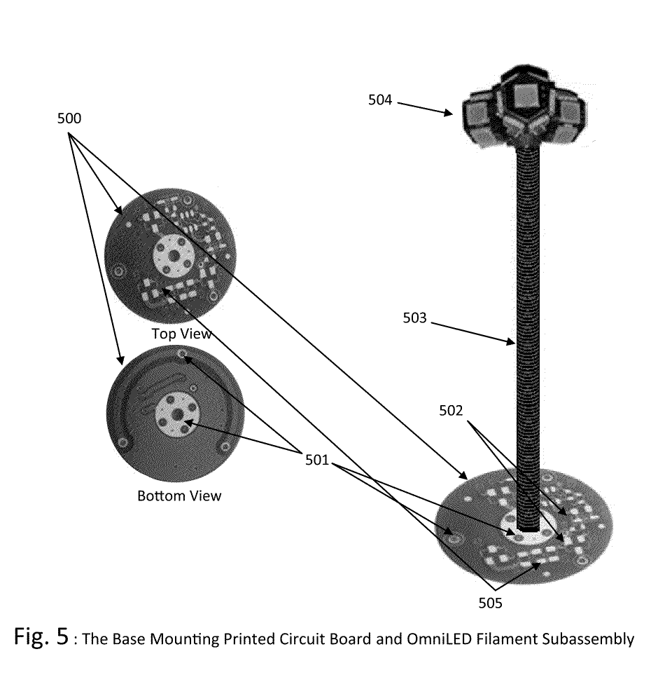

FIG. 5 illustrates The Base Mounting Printed Circuit Board and OmniLED Filament Subassembly of one embodiment. The Base Printed Circuit Board [500] has a top view and bottom view and a finished subassembly view.

The AC power enters from the Base into the Base Printed Circuit Board at [501] through the center for one lead and via the tripod pins around the edge for the other lead. Then the power is routed to the two half-bridges [502] in this embodiment.

There are two half-bridge rectifiers [502] mounted on the Base Printed Circuit Board [500] in this embodiment. The two half-bridge parts (e.g. MMBD1403) form a full wave bridge rectifier. Some embodiments may use a single chip bridge rectifier (e.g. DF02).

The stem support structure [503] is a hollow copper tube with horizontal fins in this embodiment. It could be any thermally conductive material. It could also have vertical or spiral fins or no fins at all. This embodiment is a 0.093 diameter with a 0.040″ hole through the center. In this embodiment a bifilar insulated wire is routed up the inside of the tube and soldered to the OmniLED Filament subassembly [504] on the top. Note that the OmniLED Filament Subassembly in [504] is the same one we built up in [409] in this particular embodiment.

There is an optional component [505] which may be stuffed with a zero Ohm Resistor or shorted out or stuffed with another value of resistor to limit or modify the light output. It may also be stuffed with a capacitor.

FIG. 6 illustrates the Bulb Enclosure, the OmniLED Filament Subassembly, the Base and the top level Assembly of one embodiment.

The bulb enclosure body [600] is formed using a blow molding machine similar to the Norland BM-4500 or Norland BM-600 or equivalents. The base of the bulb is formed into a screw shape similar to a plastic bottle cap area on a drink bottle, except the thread pattern is formed to match the screw pattern on the base of a standard A19 light bulb instead of a bottle cap. The base is a standard Edison Base for A19 light bulbs.

OmniLED Filament Subassembly [601] is the rollup assembly of the elements in FIG. 5, [500], [503], and [504]. It is attached using a small screw (e.g. #1/72 into the Base [602], although it may be riveted, soldered or spot welded as well.

The Base may be tin, aluminum or other conductive metal. In this particular embodiment it's aluminum, fabricated similar to aluminum pop cans or beer cans utilizing electromagnetics with a multi-cavity mold, although it could be an off-the-shelf Edison Base. The OmniLED design makes use of inexpensive existing materials as well.

The final assembly of the bulb is illustrated in [603]

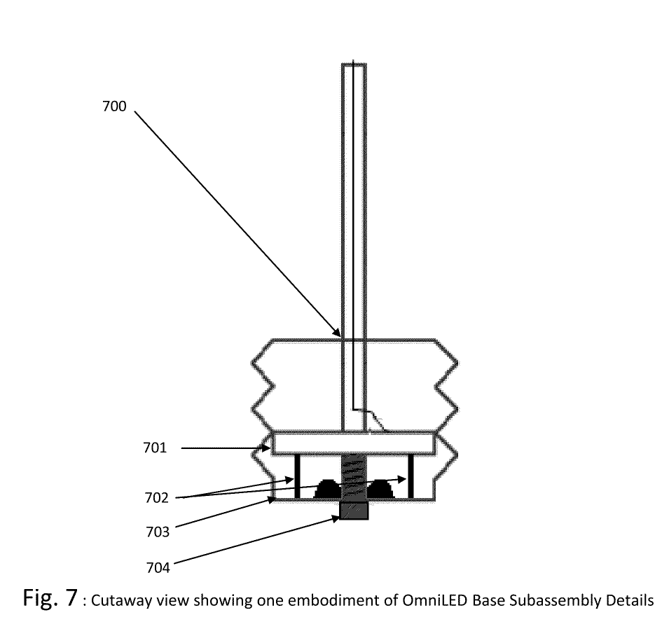

FIG. 7 illustrates a cutaway view of the base to reveal some assembly details of one embodiment.

The bottom part of the bulb [700] in cutaway view reveals the Baseboard [701] with the tripod pins that support it [702] while making electrical contact to the Base [703]

In this embodiment a #1/72 screw [704] secures the entire subassembly to the base and makes electrical connection to the center AC contact. Other embodiments are secured by a rivet or soldering or brazing.

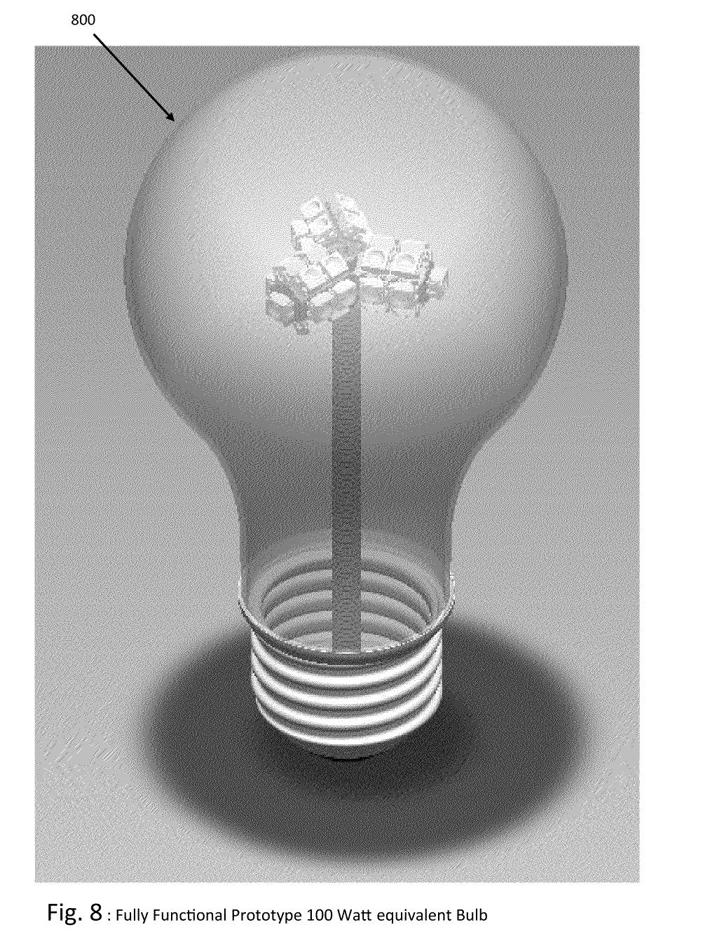

One of the fully functional 100 Watt equivalent prototype OmniLED bulbs [800] is illustrated in FIG. 8.

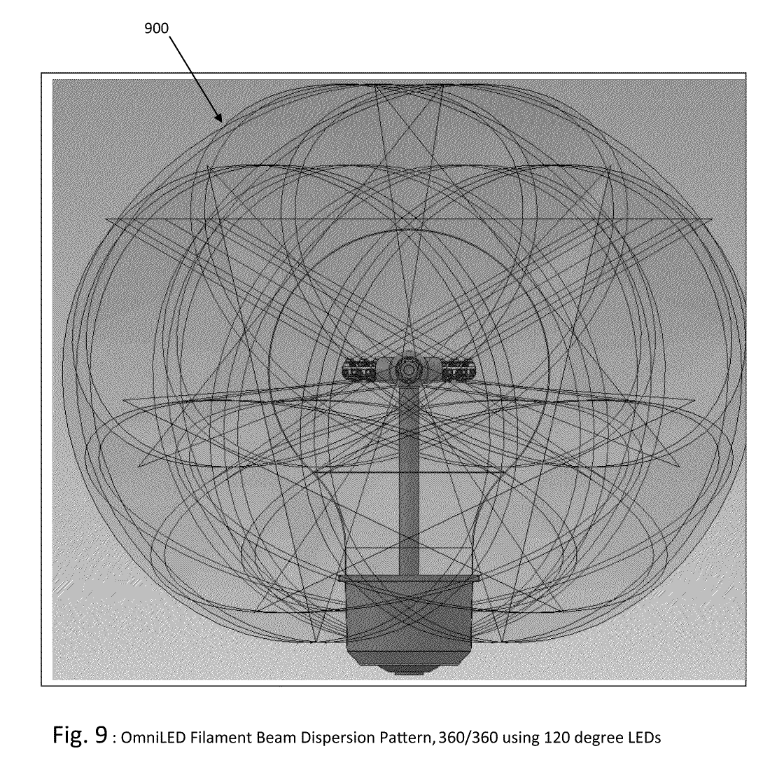

FIG. 9 illustrates the OmniLED Filament Finite Element Beam Dispersion Pattern using 120 degree LEDs with SolidWorks 2010. The Finite Element Beam Dispersion Pattern [900] shows excellent 360 degree coverage. There's an optional hemispherical mirror, not shown in the drawings, that mounts in the base around the stem which reflects any light going straight down into the base and increases the efficiency even more.

A OmniLED subassembly may also be formed in a flat line 1000 and folded into a tall triangular shaped column to replace the filament in the bulb 1001. The triangle on one end of 1000 is folded under and adhered to form the filament base

The OmniLED subassembly may also be formed in a flat line like 1000 except double wide with a hexagonal base, then wrapped around a tube 1002 to replace Fluorescent lights. In one embodiment they are wired in parallel on the DC side of the Full wave rectifier bridge. In another embodiment, a separate bridge was used for each OmniLED Filament, in which case the AC sides were wired in parallel. Multiples of the triangular or hexagonal shaped cylinders may concatenated to fill the entire tube 1002.

In another embodiment, the long arrays two bulbs wide were concatenated side by side as well as lengthwise and wired in parallel to fill the entire 360 degrees around the tube as well as the length of the tube on T5 and T8 size bulbs, although it would work on other sizes as well.

In a low cost embodiment, the triangular arrays were attached to the bottom side only of a hexagonal shaped cylinder in parallel to fill only 180 degrees instead of the full 360 degrees around the cylinder, only the side that's exposed, in order to save cost.

While the subject matter disclosed herein has been described by way of example and in terms of the specific embodiments, it is to be understood that the claimed embodiments are not limited to the explicitly enumerated embodiments disclosed. To the contrary, the disclosure is intended to cover various modifications and similar arrangements as would be apparent to those skilled in the art. Therefore, the scope of the appended claims should be accorded the broadest interpretation so as to encompass all such modifications and similar arrangements. It is to be understood that the above description is intended to be illustrative, and not restrictive. Many other embodiments will be apparent to those of skill in the art upon reading and understanding the above description. The scope of the disclosed subject matter is therefore to be determined in reference to the appended claims, along with the full scope of equivalents to which such claims are entitled.

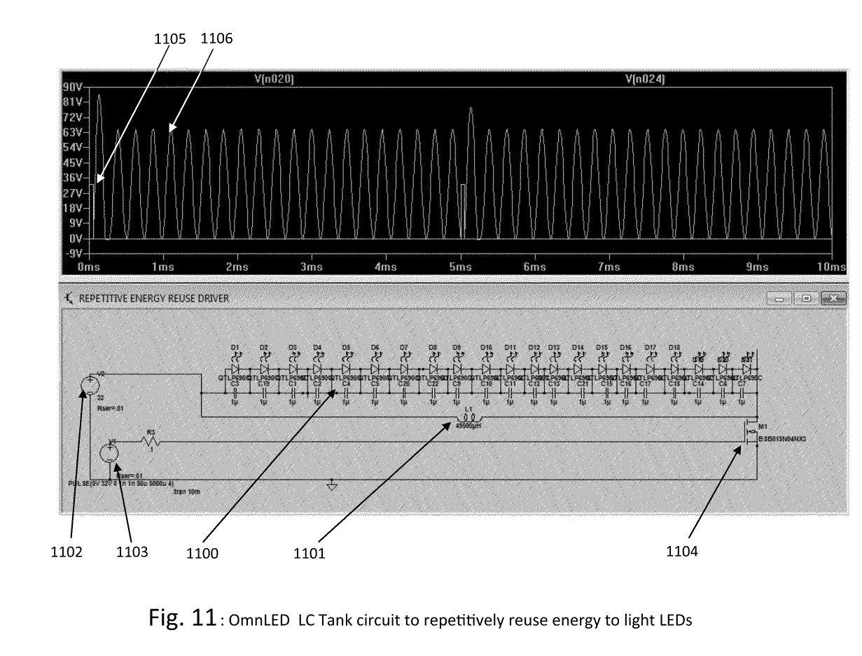

FIG. 11 illustrates the SPICE model for the OmniLED LC Tank circuit that reuses a pulse of energy again and again to light the LEDs repetitively until the resonance decays due to the resistance of the LEDs.

Each LED has a capacitor in parallel [1100] and there's an inductor [1101] in parallel with the capacitors and LED array to form a parallel LCR Tank circuit. The high voltage DC is applied to the array [1102] and the pulse circuit [1103] supplies the pulse to the low side NFET driver [1104].

The pulse signal [1105] is a very low duty cycle (less than 5% duty cycle). The short pulse activates the LRC circuit into resonance [1106] and the LED array is turned on and off rapidly, several times before the resonance damps down due to the resistance of the LEDs.

The energy used is less than 5% of the energy that would be used if the LEDs were full on continuously. The resultant light output is actually brighter than if the LED's were on continuously, due to the physiological effects pulsing has on the human eye.

A SPICE model for the OmniLED LC Series resonant circuit illustrates that it can repetitively reuse energy to light LEDs thereby requiring a very small duty cycle, conserving energy.

A short pulse periodically activates the Inductor and the series LRC circuit into resonance and the LED array is turned on and off rapidly, several times before the resonance damps down due to the resistance of the LEDs

Other embodiments have also been disclosed and described.

What is claimed is:

1. An LED bulb comprising: an LC tank circuit tuned to a resonant frequency such that it recycles an energy pulse to extract more light without using more energy as oscillations damp down.

2. The LED bulb of claim 1, configured to run at a low enough temperature that it can be housed in a blow-molded, shatter resistant plastic enclosure without melting said plastic enclosure.

3. The LED bulb of claim 1, further comprising a screw port configured to allow filling with Helium for maximum thermal absorption.

4. The LED bulb of claim 1, configured to be powered directly from rectified High Voltage AC without a low voltage DC power supply.

5. The LED bulb of claim 1, wherein the bulb is a standard A19 incandescent bulb.

6. The LED bulb of claim 1 configured to produce light substantially equal in all directions, equivalent to a standard A19 incandescent bulb, with 360 degree azimuth, and 360 degree elevation, without the use of large heat sinks or liquids.

7. An LED bulb comprising: a Series LRC circuit tuned to a resonant frequency such that it recycles short energy pulses to extract more light without using more energy as oscillations damp down.

8. The LED bulb of claim 7, configured to run at a low enough temperature that it can be housed in a blow-molded, shatter resistant plastic enclosure without melting said plastic enclosure.

9. The LED bulb of claim 7, further comprising a screw port configured to allow filling with Helium for maximum thermal absorption.

10. The LED bulb of claim 7, configured to be powered directly from rectified High Voltage AC without a low voltage DC power supply.

11. The LED bulb of claim 7, wherein the bulb is a glass standard A19 incandescent bulb.

12. The LED bulb of claim 7 configured to produce light substantially equal in all directions, equivalent to a standard A19 incandescent bulb, with 360 degree azimuth, and 360 degree elevation, without the use of large heat sinks or liquids.

13. An LED bulb which comprising:
(a) an OmniLED filament assembly comprising a flexible printed circuit board (PCB) and LED lights;
(b) an OmniLED stem configured to support the OmniLED Filament; and a
(c) transparent bulb housing that encloses the OmniLED filament and OmniLED stem.

14. The LED bulb of claim 13, wherein the flexible PCB is rolled into a hub and a plurality of legs.

15. The LED bulb of claim 14, wherein the legs have a cross-sectional shape selected from the group consisting of: square, rectangle, triangle, pentagon, hexagon, heptagon, and octagon.

16. The LED bulb of claim 14, wherein the hub of the flexible PCB is operably coupled to a bifilar wire that traverses up through the OmniLED stem.

17. An LED bulb of claim 13, further comprising: an LC tank circuit tuned to a resonant frequency such that it recycles an energy pulse to extract more light without using more energy as oscillations damp down.

18. The LED bulb of claim 13, wherein the bulb housing is a blow-molded, shatter resistant plastic and the bulb is configured to run at a low enough temperature that it without melting said bulb housing.

19. The LED bulb of claim 13, configured to be powered directly from rectified High Voltage AC without a low voltage DC power supply.

20. The LED bulb of claim 13 configured to produce light substantially equal in all directions, equivalent to a standard A19 incandescent bulb, with 360 degree azimuth, and 360 degree elevation, without the use of large heat sinks or liquids.
